(19) United States
(12) Patent Application Publication
(10) Pub. No.: US 2011/0228814 A1
(43) Pub. Date: Sep. 22, 2011

(54) COMMUNICATION DEVICE

(75) Inventor: Takanori Washiro, Kanagawa (JP)

(73) Assignee: Sony Corporation, Tokyo (JP)

(21) Appl. No.: 13/044,620

(22) Filed: Mar. 10, 2011

(30) Foreign Application Priority Data
Mar. 18, 2010 (JP) 2010-062579

(51) Int. Cl. H04B 1/69

(52) U.S. Cl. 375/130; 375/E01.001

(57) ABSTRACT

A communication device includes a case, a high frequency coupler that is disposed inwards from the surface of the case so as to be spaced apart from the surface and transmits and receives a signal of an induction electric field, and a surface wave transmission path that is disposed between the radiation surface of the induction electric field of the high frequency coupler and the surface of the case.

### BACKGROUND OF THE INVENTION

1. Field of the Invention

The present invention relates to a communication device which transmits a large volume of data in a proximate distance through a weak UWB communication method using a high frequency broadband, and more particularly to a communication device which employs a weak UWB communication using an electric field coupling and suppress variation in the resonant frequency in circumstances of being surrounded by a fluid having great permittivity.

2. Description of the Related Art

A noncontact communication method has been widely used as a medium for authentication information or other value information such as electronic money. Also, in recent years, examples of new applications of a noncontact communication system include a large volume data transmission such as downloading or streaming of video, music, or the like. The large volume data transmission is completed by a single user as well, further is preferably completed with the same sense of access time as the authentication and billing process in the related art, and thus it is necessary to heighten the communication rate. A general RFID specification uses 13. 56 MHz band and is a proximity type (from 0 to 10 cm) noncontact bidirectional communication which employs electromagnetic induction as a main principle, but the communication rate is only 106 kbps to 424 kbps. In contrast, as a proximity wireless transmission technique applicable to high speed communication, there is TransferJet (for example, see Japanese Patent No. 4345849 and www.transferjet.org/en/index.html (searched on Mar. 2, 2010). This proximity wireless transmission technique (TransferJet) employs a method of transmitting signals using an electric field coupling action, wherein a high frequency coupler of the communication device includes a communication circuit unit which processes high frequency signals, a coupling electrode which is disposed spaced apart from a ground with a certain height, and a resonance unit which effectively supplies high frequency signals to the coupling electrode.

If the proximity wireless transmission function is manufactured in a small size, it is suitable for built-in use, and, for example, it can be mounted in a variety of information devices such as a personal computer or a portable telephone. Here, a proximity wireless transmission using a weak UWB mainly employs an induction electric field of a longitudinal wave E_{R} of an electric field generated by a coupling electrode (described later), thus the electric field signal rapidly decreases at a short distance, and the communicationable range is only in 2 to 3 cm. For this reason, in built-in use, the high frequency coupler is preferably disposed to be as close to the surface of the case as possible.

On the other hand, as a form of using information devices mounted with the proximity wireless transmission function, the information devices may be used not in air but in water. However, permittivity of water is much greater than that of air, the resonant frequency of the high frequency coupler decreases due to the influence of water close to the high frequency coupler, and thus there is a problem in that a coupling intensity of a frequency used in the communication is weakened. Particularly in seawater, originally, the electric field signal is easily absorbed and the communicationable distance tends to be short. Therefore, if communication is to be performed in water, it is necessary for the resonant frequency not to vary even in water.

In order to reduce the influence of the permittivity of water, the high frequency coupler may be disposed inwards from the case surface so as to be spaced apart from the surface. However, the electric field signal is attenuated while reaching the case surface, and thus there is no preventing the communicationable range from being shortened.

### SUMMARY OF THE INVENTION

It is desirable to provide an excellent communication device capable of transmitting a large volume of data at a proximate distance by a weak UWB communication method using a high frequency broadband.

It is also desirable to provide an excellent communication device which employs a weak UWB and can suppress variation the resonant frequency in circumstances of being surrounded by fluid having great permittivity and can prevent a reduction in the communicationable range.

According to an embodiment of the present invention, there is provided a communication device including a case; a high frequency coupler that is disposed inwards from a surface of the case so as to be spaced apart from the surface and transmits and receives a signal of an induction electric field; and a surface wave transmission path that is disposed between a radiation surface of the induction electric field of the high frequency coupler and the surface of the case. The high frequency coupler according to an embodiment of the present invention includes a coupling electrode that is connected to one end of the transmission path and accumulates a charge; a ground that is disposed to face the coupling electrode and accumulates a reflected image charge of the charge; a resonance unit that increases a current flowing into the coupling electrode by installing the coupling electrode at a part where a voltage amplitude of a standing wave generated when the high frequency signal is supplied becomes great; and a support unit that is constituted by a metal line connected to the resonance unit at a nearly central position of the coupling electrode, wherein a microscopic dipole formed by a line segment connecting a center of the charge accumulated in the coupling electrode to a center of the reflected image charge accumulated in the ground is formed, and wherein the induction electric field signal of the longitudinal wave is output towards a coupling electrode of a communication partner side which is disposed to face the coupling electrode such that an angle θ formed in the direction of the microscopic dipole becomes nearly 0 degrees.

The surface wave transmission path according to an embodiment of the present invention is constituted by a metal line.

The surface wave transmission path of the communication device according to an embodiment of the present invention is constituted by a dielectric rod.

According to the present invention, it is possible to provide an excellent communication device capable of transmitting a large volume of data at a proximate distance by a weak UWB communication method using a high frequency broadband.

It is possible to provide an excellent communication device which employs a weak UWB and can suppress variation the resonant frequency in circumstances of being surrounded by fluid having great permittivity and can prevent a reduction in the communicationable range.

In the communication device according to an embodiment of the present invention, it is possible to suppress variation in the resonant frequency due to influence of permittivity of water when the communication device is used in water by disposing the high frequency coupler inwards from the case surface so as to be spaced apart from the surface, and it is possible to propagate an electric field signal to the case surface with a low loss by disposing the surface wave transmission path between the radiation surface of the induction electric field of the high frequency coupler and the case surface.

Other purposes, features or advantages of the present invention will become apparent through more detailed description based on embodiments of the present invention or the accompanying drawings.

### BRIEF DESCRIPTION OF THE DRAWINGS

FIG. 1 is a schematic diagram illustrating a configuration of a proximity wireless transmission system by a weak UWB communication method.

FIG. 2 is a diagram illustrating a basic configuration of a high frequency coupler which is respectively disposed in a transmitter and a receiver.

FIG. 3 is a diagram illustrating an example where the high frequency coupler shown in FIG. 2 is installed.

FIG. 4 is a diagram illustrating an electric field by a microscopic dipole.

FIG. 5 is a diagram illustrating mapping the electric field shown in FIG. 4 onto the coupling electrode.

FIG. 6 is a diagram illustrating a configuration example of a capacity loaded antenna.

FIG. 7 is a diagram illustrating a configuration example of the high frequency coupler in which a distributed constant circuit is used in a resonance unit.

FIG. 8 is a diagram illustrating a state where a standing wave is generated on a stub in the high frequency coupler shown in FIG. 7.

FIG. 9 is a diagram illustrating a state where the high frequency coupler is disposed close to the surface of the case of an information device.

FIG. 10 is a diagram illustrating a state where the information device in which the high frequency coupler is disposed close to the case surface is in water.

FIG. 11 is a diagram illustrating the result of measuring the coupling intensity between high frequency couplers in each frequency which is used, when the information device in which the high frequency coupler is embedded is in air, in fresh water, and in seawater.

FIG. 12 is a diagram illustrating a state where the high frequency coupler is disposed inwards from the case surface so as to be spaced apart from the surface.

FIG. 13 is a diagram illustrating a configuration example of an information device in which a surface wave transmission path is formed between a radiation surface of an induction electric field of a high frequency coupler, which is disposed inwards from the surface of the case so as to be spaced apart from the surface, and the case surface.

FIG. 14 is a diagram illustrating another configuration example of an information device in which a surface wave transmission path is formed between a radiation surface of an induction electric field of the high frequency coupler, which is disposed inwards from the case surface so as to be spaced apart from the surface, and the case surface.

### DESCRIPTION OF THE PREFERRED EMBODIMENTS

Hereinafter, embodiments of the present invention will be described with reference to the accompanying drawings.

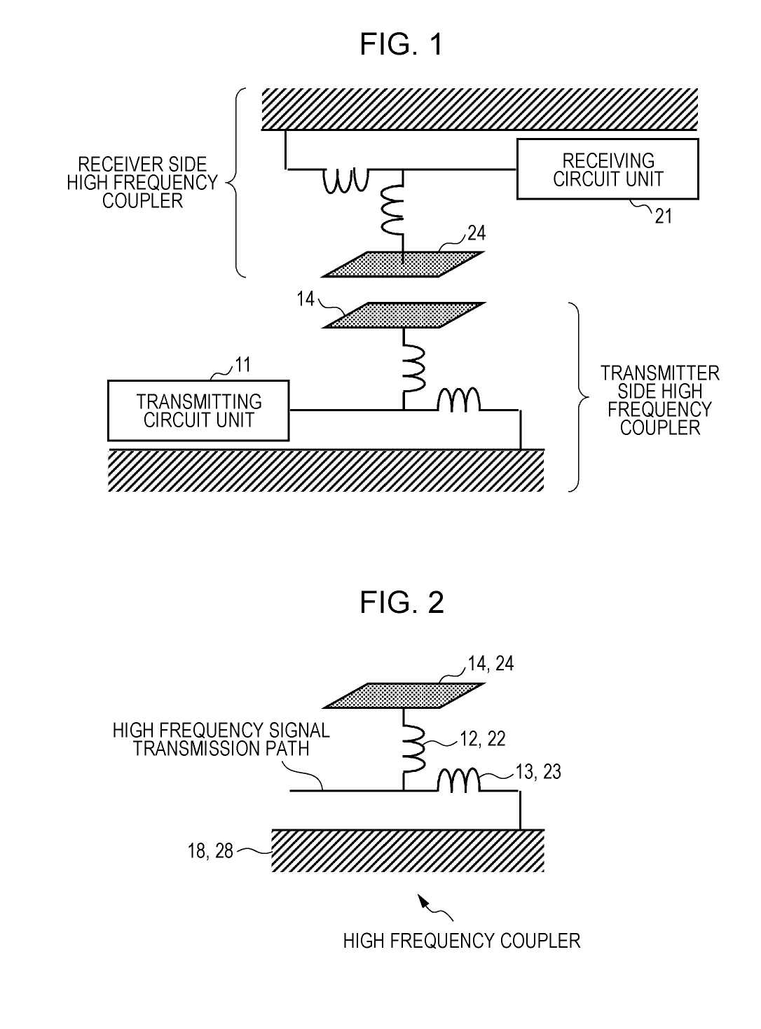

FIG. 1 schematically shows a configuration of a proximity wireless transmission system by a weak UWB communication method using an electric field coupling action. In the figure, coupling electrodes 14 and 24 which are used for transmission and reception are respectively included in a transmitter 10 and a receiver 20 are disposed facing each other with a gap of, for example, about 3 cm (or about half the wavelength in the frequency band which is used) and realize an electric field coupling. If receiving a transmission request from a higher rank application, a transmitting circuit unit 11 of the transmitter side generates a high frequency transmitted signal such as a UWB signal based on the transmitted data, and the generated signal is propagated from the transmitting electrode 14 to the receiving electrode 24 as an electric field signal. A receiving circuit unit 21 of the receiver 20 demodulates and decodes the received high frequency electric field signal and sends the reproduced data to the higher rank application.

If the UWB is used in the proximity wireless transmission, it is possible to realize an ultra-high speed data transmission of about 100 Mbps. Also, in the proximity wireless transmission, as described later, instead of the radiation electric field, an electrostatic field or an induction electric field coupling action is used. Since the field intensity is inversely proportional to the cube or the square of a distance, the field intensity within a distance of 3 meters from wireless equipment is limited to a predetermined level or less, and thus the proximity wireless transmission system can perform weak wireless communication which is unnecessary for licensing of radio stations. Therefore, the proximity wireless transmission system can be configured at a low cost. Also, since data communication is performed by the electric field coupling method in the proximity wireless transmission, there are advantages in that the number of reflected waves from peripheral reflection objects is small, thus there is little influence from interference, and it is unnecessary to take into consideration the prevention of hacking or of securing confidentiality on a transmission path.

In the wireless communication, a propagation loss increases in proportion to the propagation distance with respect to a wavelength. In the proximity wireless transmission using the high frequency broadband signal like in the UWB signal, the communication distance of about 3 cm corresponds to about half the wavelength. In other words, the communication distance may not be disregarded even if it is proximate, and it is necessary to suppress the propagation loss to a sufficiently low degree. Particularly, the characteristic impedance problem is more serious in the high frequency circuit than in the low frequency circuit, and thus the influence of the impedance mismatching in the coupling point between the electrodes of the transmitter and the receiver is manifested.

For example, in the proximity wireless transmission system shown in FIG. 1, even when the transmission path for the high frequency electric field signal connecting the transmitting circuit unit 11 to the transmitting electrode 14 is a coaxial line having an impedance matching of, for example, 50Ω, if the impedance in the coupling portion between the transmitting electrode 14 and the receiving electrode 24 is mismatched, the electric field signal is reflected and thus the propagation loss occurs. Thereby, communication efficiency is lowered.

Therefore, as shown in FIG. 2, the high frequency couplers which are respectively included in the transmitter 10 and the receiver 20 are connected to the high frequency signal transmission path via resonance units respectively including the plate-shaped electrodes 14 and 24, serial inductors 12 and 22, and parallel inductor 13 and 23. The high frequency signal transmission path described here may include a coaxial cable, a microstrip line, a coplanar line, and the like. If the high frequency couplers are disposed to face each other, the coupling portion works as a bandpass filter at a very proximate distance where a quasi-electrostatic field is dominant and thus can transmit a high frequency signal. In addition, even at a distance where the induction electric field is dominant and which may not be disregarded with respect to the wavelength, the high frequency signal can be effectively transmitted between the two high frequency couplers via the induction electric field generated from a microscopic dipole (described later) formed by charges and reflected image charges which respectively gather in the coupling electrode and the ground.

Here, between the transmitter 10 and the receiver 20, that is, in the coupling portion, if it is a purpose only to pick the impedance matching and suppress the reflected waves, even using a simple structure in which the plate-shaped electrodes 14 and 24 and the serial inductors 12 and 22 are connected in series on the high frequency signal transmission path for each coupler, it is possible to make a design such that impedance in the coupling portion is consecutive. However, there is no variation in the characteristic impedance before and after the coupling portion, and thus the magnitude of the current does not vary. In contrast, the installation of the parallel inductors 13 and 23 causes greater charges to be sent to the coupling electrode 14 and a strong electric field coupling action to be generated between the coupling electrodes 14 and 24. When a large electric field is induced around the surface of the coupling electrode 14, the generated electric field is a longitudinal wave electric field signal oscillating in a progress direction (direction of the microscopic dipole: described later) and propagates from the surface of the coupling electrode 14. Due to this electric field wave, even when the distance (phase length) between the coupling electrodes 14 and 24 is relatively large, the electric field signal can be propagated.

In summary of the above description, in the proximity wireless transmission system by the weak UWB communication method, conditions which the high frequency coupler has are as follows.

(1) There are coupling electrodes, facing a ground, to be coupled by an electric field, which are spaced apart from each other with a height which can be disregarded with respect to the wavelength of a high frequency signal.

(2) There are resonance units for coupling by a stronger electric field.

(3) In a frequency band used in communication, when coupling electrodes are disposed to face each other, a constant of a capacitor or a length of a stub is set by serial and parallel inductors and the coupling electrodes so as to pick the impedance matching.

In the proximity wireless transmission system shown in FIG. 1, if the coupling electrodes 14 and 24 of the transmitter 10 and the receiver 20 face each other with an appropriate distance, the two high frequency couplers work as a bandpass filter which allows an electric field signal in a desired high frequency band to be passed, a single high frequency coupler works as an impedance conversion circuit which amplifies a current, and a current having a large amplitude flows to the coupling electrode. On the other hand, when the high frequency coupler lies independently in a free space, since the input impedance of the high frequency coupler does not match the characteristic impedance of the high frequency signal transmission path, a signal entering the high frequency signal transmission path is reflected inside the high frequency coupler and is not radiated outwards, and thus there is no effect on other communication systems present in the vicinity thereof. That is to say, the transmitter side does not release the electric wave when a communication partner does not exist, unlike the antenna in the related art, and the impedance matching disappears only when a communication partner comes close to the transmitter side, thereby transmitting a high frequency high frequency signal.

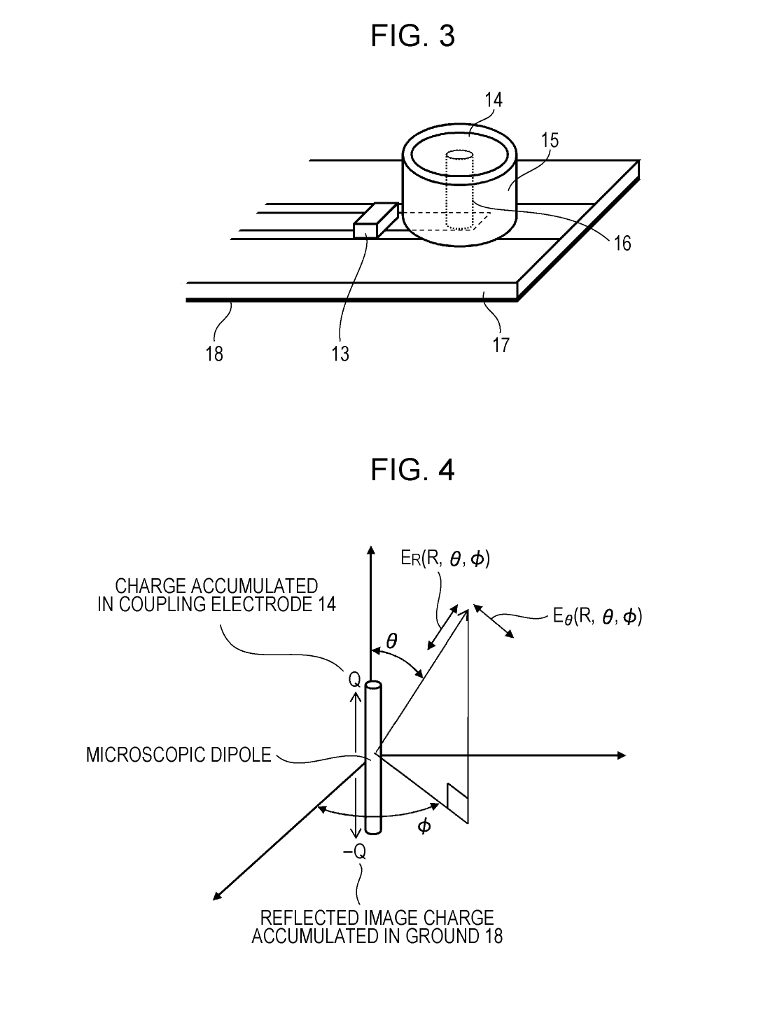

FIG. 3 shows an example where the high frequency coupler shown in FIG. 2 is installed. Any high frequency coupler of the transmitter 10 and the receiver 20 may be configured in the same manner. In the same figure, the coupling electrode 14 is installed on a spacer 15 constituted by a dielectric and is electrically connected to the high frequency signal transmission path on a print board 17 via a through-hole 16 which penetrates the spacer 15. In the same figure, the spacer 15 has a roughly pillar shape, and the coupling electrode 14 has a roughly circular shape, but these are not limited to having a specific shape.

For example, after the through-hole 16 is formed in a dielectric with a desired height, the through-hole 16 is filled with a conductor, and a conductor pattern which will be the coupling electrode 14 is deposited on the upper end surface of the dielectric by, for example, a plating technique. A wire pattern which is the high frequency signal transmission path is formed on the print board 17. The spacer 15 is installed on the print board 17 by a reflow soldering or the like, and thereby the high frequency coupler can be manufactured. The height from the surface (or the ground 18) with circuits of the print circuit 17 to the coupling electrode 14, that is, the length of the through-hole 16 is appropriately adjusted according to a wavelength which is used, and thereby the through-hole 16 has inductance and thus can replace the serial inductor 12 shown in FIG. 2. In addition, the high frequency signal transmission path is connected to the ground 18 via the chip-shaped parallel inductor 13.

Here, the electromagnetic field generated from the coupling electrode 14 of the transmitter 10 side will be observed.

As shown in FIGS. 1 and 2, the coupling electrode 14, connected to one end of the high frequency signal transmission path, into which a high frequency signal output from the transmitting circuit unit 11 flows, accumulates charges therein. At this time, by the resonance action in the resonance unit constituted by the serial inductor 12 and the parallel inductor 13, a current flowing into the coupling electrode 14 via the transmission path is amplified and greater charges are accumulated.

The ground 18 is disposed to face the coupling electrode 14 with a gap of a height which can be disregarded with respect to a wavelength of the high frequency signal. As described above, if the charges are accumulated in the coupling electrode 14, reflected image charges are accumulated in the ground 18. If a point charge Q is placed outside a planar conductor, a reflected image charge −Q (which virtually replaces the surface charge distribution) is disposed inside the planar conductor, which is known in the art, as disclosed in “Electromagnetics” (SHOKABO PUBLISHING Co., Ltd., page 54 to page 57) written by Tadashi Mizoguchi.

As described above, as a result of the point charge Q and the reflected image charge −Q being accumulated, a microscopic dipole formed by a line segment connecting a center of the charges accumulated in the coupling electrode 14 to a center of the reflected image charge accumulated in the ground 18 is formed. Strictly speaking, the charge Q and the reflected image charge −Q have a volume, and the microscopic dipole is formed so as to connect the center of the charge to the center of the reflected image charge. The “microscopic dipole” described here means that “the distance between the charges of the electric dipole is very short.” For example, the “microscopic dipole” is also disclosed in “Antenna and electric wave propagation (CORONA PUBLISHING CO., LTD. pages 16 to 18) written by Yasuto Mushiake.” Further, the microscopic dipole generates a transverse wave component E_{θ} of the electric field, a longitudinal wave component E_{R} of the electric field, and a magnetic field H_{φ} around the microscopic dipole.

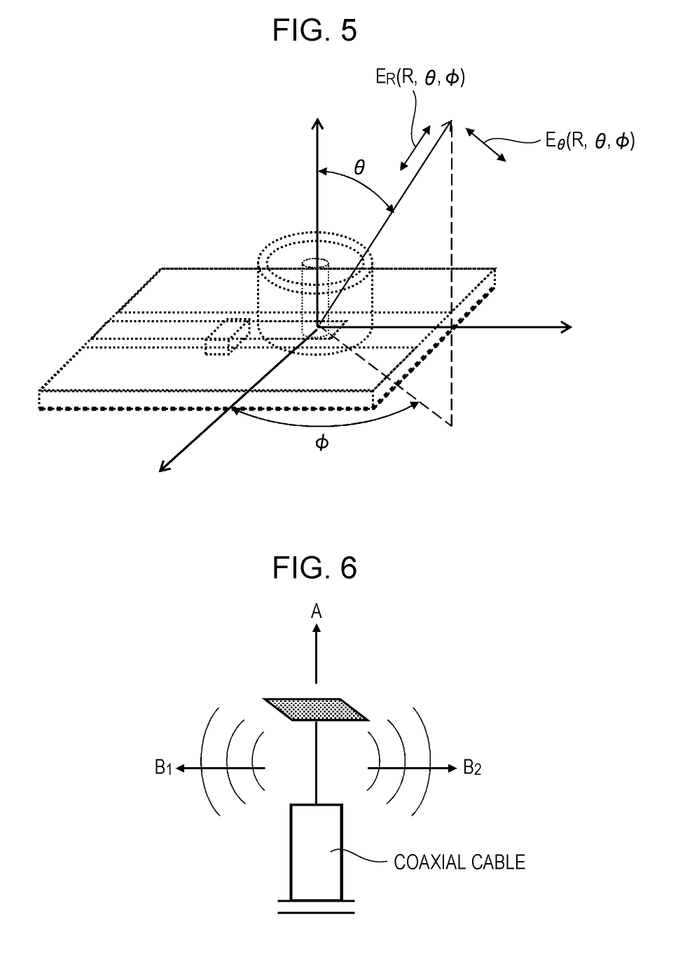

FIG. 4 shows the electric field generated by the microscopic dipole. Also, FIG. 5 shows a state where the electric field is mapped on the coupling electrode. As shown in the figures, the transverse wave component E_{θ} of the electric field oscillates in a direction perpendicular to the propagation direction, and the longitudinal wave component E_{R} of the electric field oscillates in a direction parallel to the propagation direction. The magnetic field H_{φ} is generated around the microscopic dipole. The following equations (1) to (3) indicate electromagnetic field generated by the microscopic dipole. In the same equations, the component inversely proportional to the cube of the distance R indicates a static electromagnetic field, the component inversely proportional to the square of the distance R indicates an induction electromagnetic field, and the component inversely proportional to the distance R indicates a radiation electromagnetic field.

$$\begin{matrix}{E}_{θ} = \frac{p {e}^{- j kR}}{4 π ɛ} ( \frac{1}{{R}^{3}} + \frac{j k}{{R}^{2}} - \frac{{k}^{2}}{R} ) sin θ & ( 1 ) \\ {E}_{R} = \frac{p {e}^{- j kR}}{2 π ɛ} ( \frac{1}{{R}^{3}} + \frac{j k}{{R}^{2}} ) cos θ & ( 2 ) \\ {H}_{φ} = \frac{j ω p {e}^{- j kR}}{4 π } ( \frac{1}{{R}^{2}} + \frac{j k}{R} ) sin θ & ( 3 )\end{matrix}$$

In the proximity wireless transmission system shown in FIG. 1, in order to suppress a wave interfering with peripheral systems, it is preferable that the transverse wave component E_{θ} including a radiation electric field component is suppressed and the longitudinal wave component E_{R} not including the radiation electric field component is used. This is because as can be seen from the equations (1) and (2), the transverse wave component E_{θ} of the electric field includes the radiation electric field which is inversely proportional to the distance (that is, small distance attenuation), whereas the longitudinal wave component E_{R} does not include the radiation electric field.

First of all, in order to generate the transverse wave component E_{θ} of the electric field, it is necessary for the high frequency coupler not to work as an antenna. At a glance, the high frequency coupler shown in FIG. 2 has a structure similar to a “capacity loaded antenna” in which a metal is provided at the front end of the antenna element to have capacitance and to decrease the height of the antenna. Therefore, it is necessary for the high frequency coupler not to work as the capacity loaded antenna. FIG. 6 shows a configuration example of the capacity loaded antenna, and in the same figure, the longitudinal wave component E_{R} of the electric field is mainly generated in the direction of the arrow A, and the transverse wave component E_{θ} of the electric field is generated in the directions of the arrows B₁ and B₂.

In the configuration example of the coupling electrode shown in FIG. 3, the dielectric 15 and the through-hole 16 have combined functions of preventing coupling of the coupling electrode 14 and the ground 18 and forming the serial inductor 12. The serial inductor 12 is formed by selecting a sufficient height from the circuit mounted surface of the print circuit 17 to the electrode 14, the electric field coupling between the ground 18 and the electrode 14 is prevented and the electric field coupling with the high frequency coupler of the receiver side is secured. However, if the height of the dielectric 15 is great, that is, the distance between the circuit mounted surface of the print circuit 17 to the electrode 14 reaches a length which may not be disregarded with respect to the wavelength which is used, the high frequency coupler works as the capacity loaded antenna, and thus the transverse wave component E_{θ} as indicated by the arrows B₁ and B₂ in FIG. 6 is generated. Therefore, the height of the dielectric 15 follows a condition of a sufficient length for obtaining characteristics as the high frequency coupler by preventing the coupling between the electrode 14 and the ground 18 and for forming the serial inductor 12 used to work as an impedance matching circuit and a small length for suppressing radiation of the unnecessary electric wave E_{θ} caused by a current flowing into the serial inductor 12.

On the other hand, from the above equation (2), it can be seen that the longitudinal wave component E_{R} becomes maximal at the angle θ=0 formed in the direction of the microscopic dipole. Therefore, in order to perform the noncontact communication through the effective use of the longitudinal wave component E_{R} of the electric field, it is preferable that a high frequency coupler of a communication partner is disposed to face such that the angle θ formed in the direction of the microscopic dipole nearly becomes 0 degree, and a high frequency electric field signal is transmitted.

Further, the current of the high frequency signal flowing into the coupling electrode 14 can be made to be greater by the resonance unit including the serial inductor 12 and the parallel inductor 13. As a result, the moment of the microscopic dipole formed by the charge accumulated in the coupling electrode 14 and the reflected image charge in the ground side can be made to be large, and the high frequency electric field signal constituted by the longitudinal wave component E_{R} can be efficiently transmitted towards the propagation direction where the angle θ formed in the direction of the microscopic dipole nearly becomes 0 degrees.

In the impedance matching unit of the high frequency coupler shown in FIG. 2, an operation frequency f₀ is determined based on constants L₁ and L₂ of the parallel inductor and the serial inductor. However, in a high frequency circuit, it is known that a lumped-constant circuit has a band narrower than a distributed constant circuit, and the constant of an inductor decreases as a frequency is heightened. Thus, there is a problem in that the resonant frequency deviates due to a difference in the constants. In contrast, the impedance matching unit or the resonance unit constitutes the high frequency coupler using the distributed constant circuit instead of the lumped-constant circuit, thereby realizing broadband.

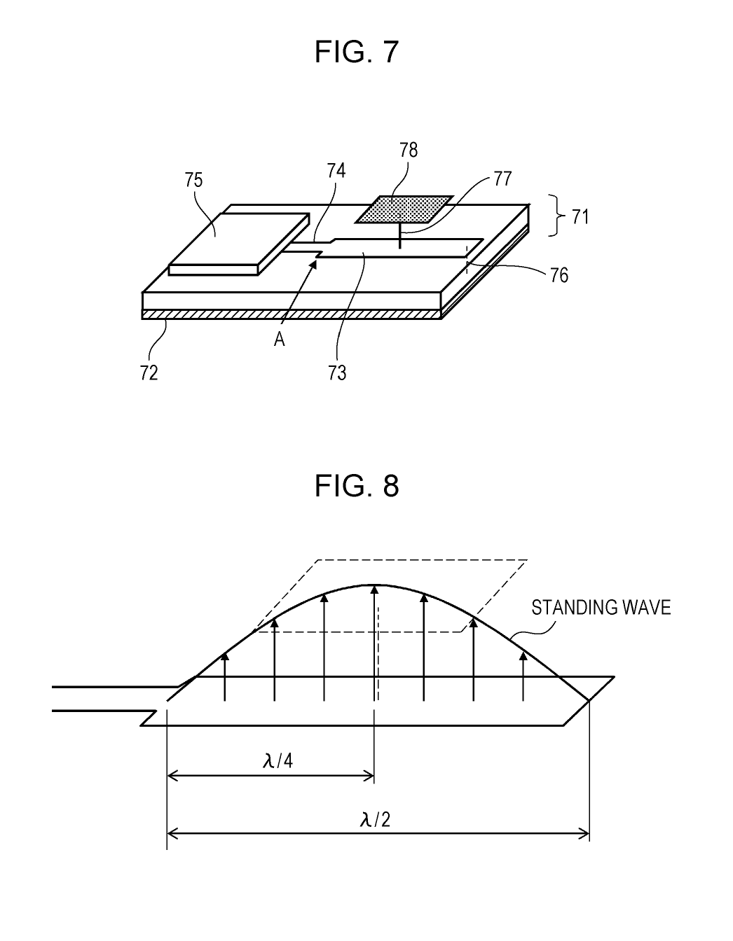

FIG. 7 shows a configuration example of the high frequency coupler using the distributed constant circuit in the matching unit or the resonance unit. In the example shown in the figure, a ground conductor 72 is formed on the bottom, and a high frequency coupler is installed on a print board 71 on which a print pattern is formed. As an impedance matching unit and a resonance unit of the high frequency coupler, instead of the parallel inductor and the serial inductor, a microstrip line or a coplanar waveguide, that is, a stub 73, which works as a distributed constant circuit, is formed, and is connected to a transmitting and receiving circuit module 75 via a signal line pattern 74. The stub 73 of which the front end is connected to the ground 72 on the bottom via a through-hole 76 penetrating the print board 71 forms a short circuit. The vicinity of the center of the stub 73 is connected to the coupling electrode 78 via a single terminal 77 constituted by a thin metal line.

A “stub” mentioned in the technical field of electronics generally refers to an electric wire of which one end is connected to an element and the other end is not connected thereto or is connected to a ground, which is provided in the middle of a circuit, and is used for adjustment, measurement, impedance matching, filters, or the like.

Here, a signal output from the transmitting and receiving circuit via the signal line is reflected in the front end portion of the stub 73, and a standing wave is generated inside the stub 73. The phase length of the stub 73 is half the wavelength of the high frequency signal (180 degrees in terms of phase), and the signal line 74 and the stub 73 are formed by a microstrip line, a coplanar line, or the like on the print board 71. As shown in FIG. 8, when the front end is short-circuited at the phase length of the stub 73 which is half the wavelength, the voltage amplitude of the standing wave generated inside the stub 73 becomes 0 at the front end of the stub 73 and becomes maximal at the center of the stub 73, that is, a place corresponding to a fourth of the wavelength (90 degrees) from the front end of the stub 73. Around the center of the stub 73 at which the voltage amplitude of the standing wave becomes maximal, the stub 73 is connected to the coupling electrode 78 via the single terminal 77, thereby forming the high frequency coupler having good propagation efficiency.

The stub 73 shown in FIG. 7 is a microstrip line or a coplanar waveguide on the print board 71, which has a low DC resistance, thus has a small loss in the high frequency signal and can diminish the propagation loss between the high frequency couplers. Since the size of the stub 73 forming the distributed constant circuit is as large as about half the wavelength of the high frequency signal, an error in dimensions due to tolerance during manufacturing is slight as compared with the entire phase length, and thus characteristic differences are difficult to generate.

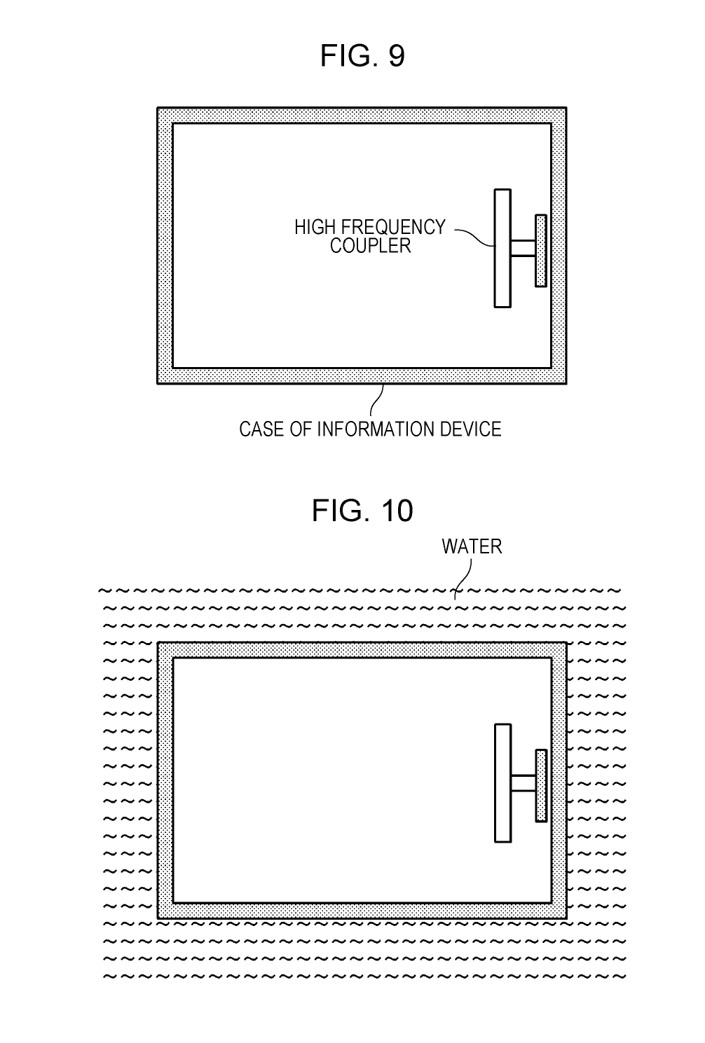

Next, a case where the proximity wireless transmission function is applied to built-in use will be observed. The proximity wireless transmission using a weak UWB mainly employs an induction electric field of a longitudinal wave E_{R} of an electric field generated by a coupling electrode, thus the electric field signal rapidly decreases at a short distance. For this reason, as shown in FIG. 9, the high frequency coupler is preferably disposed to be as close to the surface of the case as possible.

On the other hand, as a form of using information devices mounted with the proximity wireless transmission function, the information devices may be used not in air as usual but in water as shown in FIG. 10. Here, the water is dielectric, and the specific permittivity of the water is 80, which is very high. Thus, if the high frequency coupler is disposed close to the case surface, the resonant frequency of the high frequency coupler decreases due to a wavelength reduction effect.

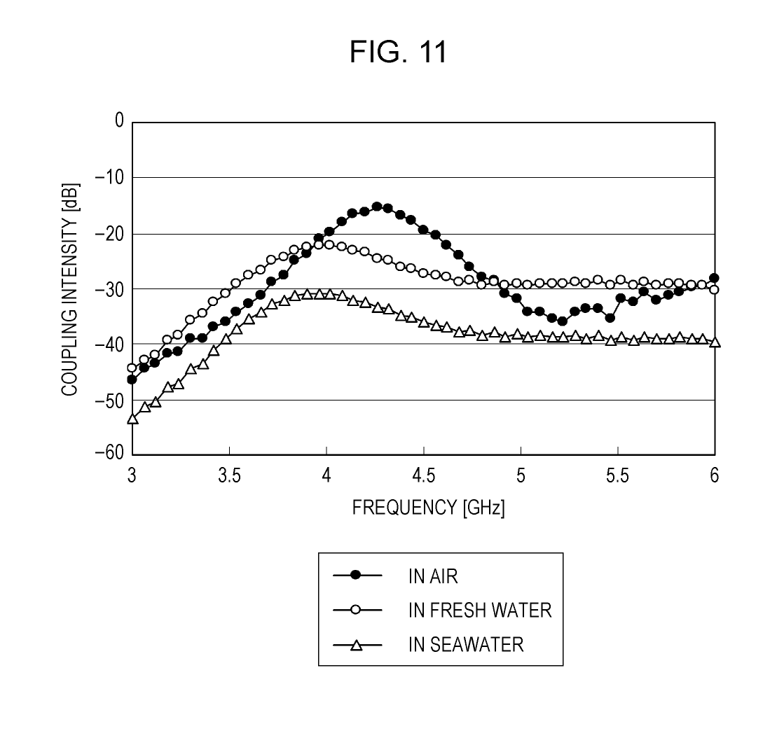

FIG. 11 is a diagram illustrating a result of measuring the coupling intensity between high frequency couplers in each frequency which is used, when the information device in which the high frequency coupler is embedded is in air, in fresh water, and in seawater (salt water with concentration of 3.5%). It can be seen from the result shown in the figure that the resonant frequency in fresh water and in seawater decreases by 10% as compared with being in air and a coupling intensity in a frequency used for communication is weakened. Also, the coupling intensity is further weakened in seawater than in fresh water, and this is because a conductor loss due to ionic conduction has an effect on the coupling intensity in seawater.

The noncontact communication including the proximity wireless transmission using the weak UWB communication method has a big advantage in that electrodes do not come into contact with a cable or the like. Therefore, there is a request not to deteriorate the performance of the high frequency coupler even in water as much as possible.

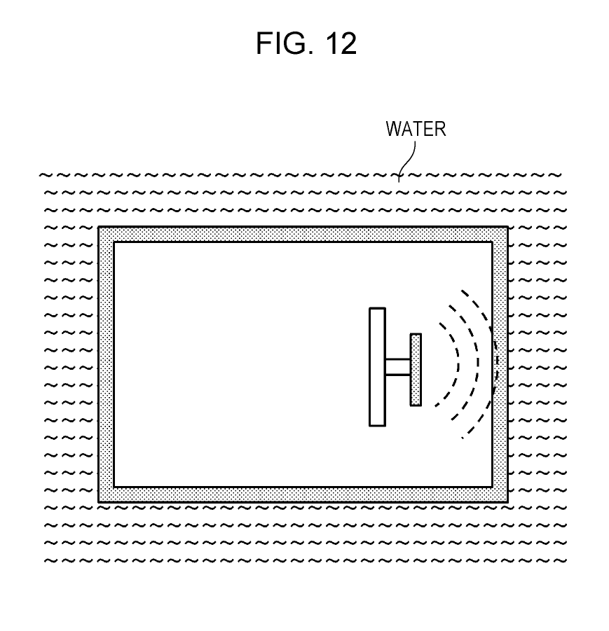

In order to reduce the influence of permittivity of water, as shown in FIG. 12, the high frequency coupler may be disposed inwards from the case surface so as to be spaced apart from the case. In this case, since the high frequency coupler in the case and the dielectric (water) are spaced apart from each other and thus the high permittivity is difficult to influence, the resonant frequency does not vary. However, the electric field signal is attenuated while reaching the case surface, and thus there is no preventing the communicationable range from being shortened.

The electric field signal is originally attenuated in a greater manner in fresh water or seawater than in air, and thus it is necessary for the electric field signal radiated from the high frequency coupler to be set to be as strong as possible.

Therefore, the present inventor proposes a configuration of the communication device where the high frequency coupler is disposed inwards from the case surface so as to be spaced apart from the surface and a surface wave transmission path is disposed between a radiation surface of an induction electric field of the high frequency coupler and the case surface. The electric field signal radiated from the high frequency coupler can be propagated along the surface wave transmission path with a low loss, to the case surface. Moreover, since the high frequency coupler is disposed inwards from the case surface so as to be spaced apart from the surface, it is possible to suppress variation in the resonant frequency due to influence of permittivity of water when performed in water and realize the proximity wireless transmission having a long communicationable distance.

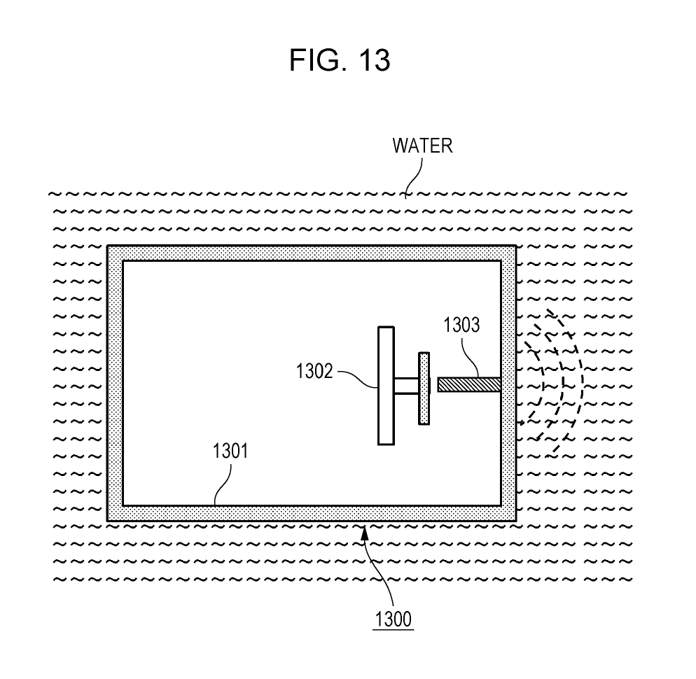

FIG. 13 is a diagram illustrating a configuration example of an information device 1300 in which a surface wave transmission path 1303 is formed between a radiation surface of an induction electric field of a high frequency coupler 1302, which is disposed inwards from the surface of the case 1301 of the information device so as to be spaced apart from the surface, and the case surface. In the example shown in the figure, the surface wave transmission path is constituted by a metal line. Japanese Unexamined Patent Application Publication No. 2008-99234 which has already been assigned to the present applicant discloses a surface wave transmission path which is constituted by a conductor such as a copper line and efficiently transmits an electric field signal radiated from a high frequency coupler via the inside and the surface.

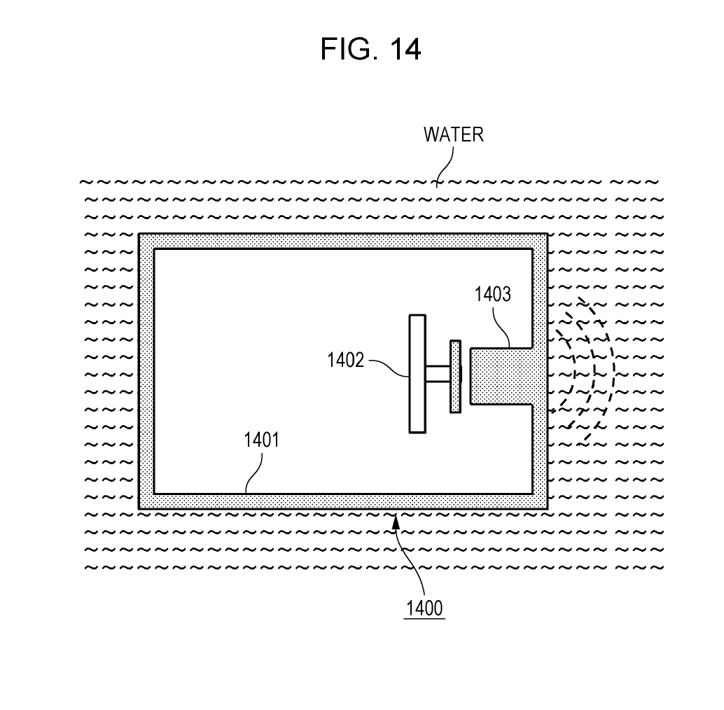

FIG. 14 is a diagram illustrating another configuration example of an information device 1400 in which a surface wave transmission path 1403 is formed between a radiation surface of an induction electric field of a high frequency coupler 1402, which is disposed inwards from the surface of the case 1401 so as to be spaced apart from the surface, and the case surface. In the example shown in the figure, the surface wave transmission path is constituted by a dielectric rod. Also, Japanese Patent No. 4345850 which has already been assigned to the present Applicant discloses a surface wave transmission path which is constituted by a line shaped member of a dielectric and efficiently transmits an electric field signal radiated from a high frequency coupler via the inside and the surface.

In a resonator such as an antenna or a high frequency coupler, the resonant frequency decreases due to influence of a dielectric close to the resonator. In contrast, the surface wave transmission path has a specific resonant frequency, and thus the resonant frequency does not vary even if it is close to a dielectric, and is not influenced by the dielectric.

According to the information devices shown in FIGS. 13 and 14, even if the information devices are in air or in water, variation in the resonant frequency in the high frequency coupler is small, and a communication situation optimal in all circumstances can be maintained.

According to the information devices shown in FIGS. 13 and 14, the electric field signal radiated from the high frequency coupler is guided to the case surface of the information device with a low loss, and thus the amount of reduction in the communicationable distance is small in air or in water.

In the specification, although the description has been made mainly based on the embodiments in which the UWB signal is applied to the communication system which transmits data through the electric field coupling without cables, the gist of the present invention is not limited thereto. For example, the present invention is also applicable to a communication system using a high frequency signal other than the UWB communication method, or a communication system which transmits data through an electric field coupling using a relatively low frequency signal or through other electromagnetic actions.

The present application contains subject matter related to that disclosed in Japanese Priority Patent Application JP 2010-062579 filed in the Japan Patent Office on Mar. 18, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A communication device comprising:
a case;
a high frequency coupler that is disposed inwards from a surface of the case so as to be spaced apart from the surface and transmits and receives a signal of an induction electric field; and
a surface wave transmission path that is disposed between a radiation surface of the induction electric field of the high frequency coupler and the surface of the case.

2. The communication device according to claim 1, wherein the high frequency coupler includes:
a coupling electrode that is connected to one end of the transmission path and accumulates a charge;
a ground that is disposed to face the coupling electrode and accumulates a reflected image charge of the charge;
a resonance unit that increases a current flowing into the coupling electrode by installing the coupling electrode at a part where a voltage amplitude of a standing wave generated when the high frequency signal is supplied becomes great; and
a support unit that is constituted by a metal line connected to the resonance unit at a nearly central position of the coupling electrode,
wherein a microscopic dipole formed by a line segment connecting a center of the charge accumulated in the coupling electrode to a center of the reflected image charge accumulated in the ground is formed, and
wherein the induction electric field signal of a longitudinal wave is output towards a high frequency coupler of a communication partner side which is disposed to face the coupling electrode such that an angle θ formed in a direction of the microscopic dipole becomes nearly 0 degrees.

3. The communication device according to claim 1, wherein the surface wave transmission path is constituted by a metal line.

4. The communication device according to claim 1, wherein the surface wave transmission path is constituted by a dielectric rod.
